(19) United States
(12) Patent Application Publication
(10) Pub. No.: US 2012/0189134 A1
(43) Pub. Date: Jul. 26, 2012

(54) EARPHONE AND ELECTRONIC DEVICE USING THE SAME

(75) Inventors: WEN-WU WANG, Shenzhen City (CN); TSUNG-JEN CHUANG, Tu-Cheng (TW); SHIH-FANG WONG, Tu-Cheng (TW); WEN-DONG LUO, Shenzhen City (CN); BIN LIU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/095,935

(22) Filed: Apr. 28, 2011

(30) Foreign Application Priority Data
Jan. 21, 2011 (CN) 201110024377.7

(51) Int. Cl. H04R 1/10

(52) U.S. Cl. 381/74

(57) ABSTRACT

An electronic device includes a main body and an earphone. The main body includes an earphone socket and a first processing unit. The earphone includes an earphone plug, a storage unit, and a second processing unit. The earphone is connected to the main body by inserting the earphone plug into the earphone socket. The storage unit stores a password. The second processing unit transmits the password to the main body when the second processing unit detects that the earphone plug is inserted into the earphone socket. The first processing unit unlocks the main body if the password received from the earphone matches a predetermined condition.

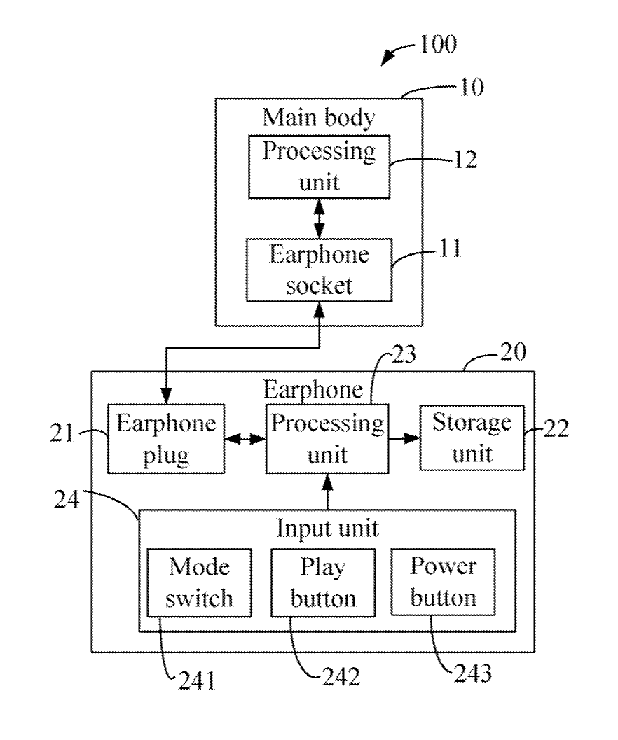

### BACKGROUND

1. Technical Field

The present disclosure relates to earphones and electronic devices having the earphones and, particularly, to an electronic device employing an earphone to unlock the electronic device.

2. Description of Related Art

Electronic devices such as mobile phones usually employ a password to lock the electronic devices in order to protect the content stored in the electronic devices. However, when users forget the password, it may be difficult to unlock the electronic devices, which may be troublesome for the users.

### BRIEF DESCRIPTION OF THE DRAWINGS

The components of the drawing are not necessarily drawn to scale, the emphasis instead being placed upon clearly illustrating the principles of an earphone and electronic device using the same.

The drawing is a schematic view of an electronic device using an earphone in accordance with an exemplary embodiment.

### DETAILED DESCRIPTION

Referring to the drawing, an electronic device 100 includes a main body 10 and an earphone 20. The main body 10 may be a mobile phone, or an audio player. The main body 10 includes an earphone socket 11 and a processing unit 12. The earphone 20 includes an earphone plug 21, a storage unit 22, a processing unit 23, and an input unit 24. In this embodiment, when the earphone plug 21 is inserted into the earphone socket 11, the earphone 20 is connected to the main body 10, and data can be transmitted between the earphone 20 and the main body 10. A detailed method of transmitting data between the earphone 20 and the main body 10 is disclosed in Chinese publication application NO. CN101149718A published on Mar. 26, 2008, which discloses how to transmit data between the earphone 20 and the main body 10.

The storage unit 22 stores a password for unlocking the main body 10. In this embodiment, the password is a primary ID of the earphone 20. In an alternative embodiment, the password can be set by users.

When the processing unit 23 detects that the earphone plug 21 is inserted into the earphone socket 11, the processing unit 23 transmits the password to the processing 12, thus the main body 10 can unlock itself using the password. When the processing unit 23 determines that a new password is input, the processing unit 23 replaces the stored password with the new password.

If the processing unit 12 determines that the password received from the earphone 20 matches a preset condition, the processing unit 12 unlocks the electronic device 10. Otherwise, the processing unit 12 generates and outputs prompt information to prompt that the earphone 20 inserted into the main body 10 is not the right earphone 20. If the processing unit 12 determines that the earphone socket 11 is in an idle state within a preset period and the main body 10 does not receive any operational signal within the preset period, the processing unit 12 locks the main body 10.

In the embodiment, when the matched earphone 20 is inserted into the main body 10, the main body 10 unlocks itself. Employing the password stored in the earphone 20 to unlock the main body 10 may not require users to remember the password.

The input unit 24 includes a mode switch 241, a play button 242, and a power button 243. The mode switch 242 generates mode switch signals in response to user input. The processing unit 23 transmits the mode switch signals to the main body 10 to direct the main body 10 to switch work modes. The play button 242 generates play control signals in response to user input. The processing unit 23 transmits the play control signals to direct the main body 10 to execute play operation, for example, adjust volume. The power button 243 generates power off signals in response to user input. The processing unit 23 transmits the power off signals to the main body 10 to direct the main body 10 to power itself off. Other function modules for operating the main body 10 may be arranged on the earphone 20, such that the earphone 20 can be used conveniently to operate the main body 10.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An earphone comprising:
an earphone plug to connect the earphone to an electronic device;
a storage unit to store a password to unlock the electronic device; and
a processing unit to transmit the password to the electronic device when the processing unit detects that the earphone plug is inserted into the electronic device.

2. The earphone as described in claim 1, wherein the password is a primary ID of the earphone.

3. The earphone as described in claim 1, wherein the processing unit is further to replace the stored password with a new password if a new password is input.

4. The earphone as described in claim 1, further comprising a mode switch to generate mode switch signals in response to user input, wherein the processing unit is further to transmit the mode switch signals to the electronic device to direct the electronic device to switch work modes.

5. The earphone as described in claim 1, further comprising a play button to generate play control signals in response to user input, wherein the processing unit is further to transmit the play control signals to the electronic device to direct the electronic device to execute play operation.

6. The earphone as described in claim 1, further comprising a power button to generate power off signals in response to user input, wherein the processing unit is further to transmit the power off signals to the electronic device to direct the electronic device to power itself off.

7. An electronic device comprising:
a main body comprising an earphone socket and a first processing unit; and
an earphone comprising an earphone plug, a storage unit, and a second processing unit, the earphone being connected to the main body by inserting the earphone plug into the earphone socket, the storage unit to store a password, the second processing unit to transmit the password to the main body when the second processing unit detects that the earphone plug is inserted into the earphone socket;
the first processing unit to unlock the main body if the password received from the earphone matches a predetermined condition.

8. The electronic device as described in claim 7, wherein the first processing unit is further to generate prompt information to prompt that the earphone is not the right earphone if the password received from the earphone does not match the predetermined condition.

9. The electronic device as described in claim 7, wherein the first processing unit is further to lock the main body if the first processing unit detects that the earphone socket is in an idle state within a preset period and the main body does not receive any operational signal within the period.

10. The electronic device as described in claim 7, further comprising a mode switch to generate mode switch signals in response to user input, wherein the second processing unit is further to transmit the mode switch signals to the main body to direct the main body to switch work modes.

11. The electronic device as described in claim 10, further comprising a play button to generate play control signals in response to user input, wherein the second processing unit is further to transmit the play control signals to the main body to direct the main body to execute play operation.

12. The electronic device as described in claim 10, further comprising a power button to generate power off signals in response to user input, wherein the second processing unit is further to transmit the power off signals to the main body to direct the main body to power off itself.
